(19) United States
(12) Patent Application Publication
(10) Pub. No.: US 2026/0133142 A1
(43) Pub. Date: May 14, 2026

(54) ARTICLE INSPECTION DEVICE

(71) Applicant: ANRITSU CORPORATION, Kanagawa (JP)

(72) Inventors: Takeshi YAMAZAKI, Kanagawa (JP); Hiroki WATANABE, Kanagawa (JP)

(21) Appl. No.: 19/302,328

(22) Filed: Aug. 18, 2025

(30) Foreign Application Priority Data
Sep. 10, 2024 (JP) 2024-156758

(51) Int. Cl. G01N 23/046

(52) U.S. Cl. CPC G01N 23/046; G01N 2223/401; G01N 2223/408; G01N 2223/6466

(57) ABSTRACT

An article inspection device includes an image storage unit that stores an inspection image by imaging an article, a determination unit that determines a quality state of the article by obtaining an inference value related to the quality state as confidence for each predetermined unit region of the inspection image and comparing with a threshold value using a learning model, an inference value image generation unit that generates an inference value image having a pixel density corresponding to the inference value, a projection image generation unit that generates a projection image by projecting a maximum value of the density corresponding to the inference value to an x-axis for a plurality of line image regions xpi present in a y-axis direction in the inference value image, and a display control unit that displays the projection image by adding a line corresponding to the threshold value.

### TECHNICAL FIELD

The present invention relates to an article inspection device, and particularly to an article inspection device that inspects a quality state of an article using an inspection image obtained by imaging an inspection object and a trained model.

### Background Art

Recently, an article inspection device that inspects a quality state of an article by applying a so-called artificial intelligence (AI) model, which is a machine-trained model, to an inspection image or a sensor signal including a feature value corresponding to the quality state of the article, and outputs an image including inspection result information by displaying the image as the inspection image has been known.

For example, in order to improve article inspection accuracy, such an article inspection device captures a plurality of images provided through different input channels under a predetermined imaging condition corresponding to each input channel, acquires image data of the plurality of images of the inspection object as a set, and stores the image data in an image storage unit. Before doing this, the article inspection device creates a trained model for inspection determination that is machine-trained using training image data acquired under the same imaging condition as the image data of the inspection object stored in the image storage unit, and obtains a quality defect degree by processing the image data of the inspection object acquired during the actual inspection for each pixel using the trained model and determines the quality state of the inspection object by comparing the quality defect degree with a threshold value set in advance (for example, see Patent Document 1).

An article inspection device using a rule-based model that executes determination or a task in accordance with an instruction or a rule defined in advance by a human has also been known. This article inspection device acquires an X-ray transmission image of an inspection object by imaging the inspection object being transported, through line scanning for each predetermined time using an X-ray line sensor, creates an X-ray inspection image of the inspection object by performing filter processing or the like for foreign object detection on the acquired image, and displays a projection diagram that displays the maximum pixel value among pixel values of the line scanning image for each predetermined time in association with a corresponding position of the inspection object in a transport direction using a bar graph, on a screen together with the X-ray inspection image in response to entry and exit of the inspection object being transported, into and from an imaging section (for example, see Patent Document 2).

### RELATED ART DOCUMENT

### Patent Document

[Patent Document 1] JP-A-2023-114828
[Patent Document 2] JP-A-2016-180712

### DISCLOSURE OF THE INVENTION

### Problem That the Invention is to Solve

In the above article inspection device of the related art, to what degree AI estimates an estimation result such as whether or not an object is a detection target with certainty may be indicated using confidence that is a score of statistical measure. In this case, in a case where the confidence exceeds a threshold value set in advance, it can be determined that an article or a spot to be detected is detected. Accordingly, reliability of a determination result can be increased.

However, in the image inspection function using AI, magnitude of an estimated value for each pixel of the inspection object image is generally represented by a heat map. In this case, a problem arises in that, even in a case where approximate magnitude of the confidence is known, information for setting a specific threshold value is not sufficient.

In outputting information about the confidence by displaying the information on an AI-based object detection system together with a rectangle, excessive overlap between a numerical value or the rectangle and a display image results in a disadvantage in that it is difficult to understand the magnitude of the confidence with respect to a position on the article in a part where detection target candidates are densely located.

Meanwhile, in the article inspection device, presence or absence of an abnormality in the article is normally inspected while transporting the inspection object, and notification is generally output when the abnormality is detected. Thus, it is desirable to clearly display at which position on the inspection object in the transport direction the abnormality is detected on the screen. However, displaying candidate images of a plurality of abnormal spots in the inspection image together with the confidence poses a problem in that it is not easy to instantly visually recognize or perceive the magnitude of the confidence or whether or not the confidence exceeds the threshold value.

Meanwhile, it is considered that, in a case where the X-ray inspection image of the inspection object is displayed by moving the X-ray inspection image in a direction of one coordinate axis corresponding to the transport direction, and the maximum value among the pixel values of the line scanning image is displayed by projecting the maximum value to the one coordinate axis, it is easy to instantly visually recognize at which position on the inspection object the abnormality is detected.

However, such a case still poses an unsolved problem in that it is difficult to visually recognize at which position in the transport direction the abnormality is detected in a case where the maximum pixel value in each line scanning image (for example, the X-ray transmission image) of the inspection object approaches the threshold value.

Therefore, an object of the present invention is to provide an article inspection device that can easily visually display at which position in a transport direction a detection target spot such as an abnormality or a candidate of the detection target spot is detected, on a display screen of an inspection image, and that can also clearly show a determination reference.

### Means for Solving the Problem

In order to achieve the above object, an article inspection device according to the present invention includes (1) an image storage unit that stores an inspection image of a transported inspection object obtained by imaging the inspection object, a determination unit that determines a quality state of the inspection object for the inspection image stored in the image storage unit by obtaining an inference value related to the quality state of the inspection object for each unit region of a predetermined number of pixels of the inspection image and comparing the inference value with a threshold value set in advance using a learning model which is trained in advance using an image dataset of the same imaging condition as the inspection object, an inference value image generation unit that generates an inference value image which is a two-dimensional shade image obtained using the inference value corresponding to the inspection image as a density, a projection image generation unit that generates a projection image in a bar graph form by projecting a maximum value of the density of each of a plurality of line image regions adjacent to each other in a direction of one coordinate axis and present in a direction of another coordinate axis in the inference value image to a corresponding line image region on the one coordinate axis with a length corresponding to the maximum value of the density, and a display control unit that displays the projection image on a display unit by adding a line corresponding to the threshold value on the projection image.

According to this configuration, in the present invention, the inference value related to the quality state of the inspection object is obtained for each unit region of the predetermined number of pixels in the inspection image, and the two-dimensional shade image obtained using the inference value as the density is generated as the inference value image. The plurality of line image regions adjacent to each other in the direction of the one coordinate axis and present in the direction of the other coordinate axis in the inference value image are displayed as a projection diagram by sequentially projecting the maximum pixel value of each line image region to any one coordinate axis in association with a transport direction or the like of the inspection object. Accordingly, it is easy to instantly visually recognize at which position in the transport direction on the inspection object or at which position in a line scanning direction an abnormality is detected. Consequently, at which position in the transport direction a detection target spot such as an abnormality or a candidate of the detection target spot is detected can be easily visually displayed on a display screen of the inspection image, and a determination reference can also be clearly shown.

In a preferred embodiment of the present invention, (2) the display control unit may display the inspection image or the inference value image and the projection image in the bar graph form on the display unit by aligning positions of the plurality of line image regions and the corresponding line image regions in the direction of the one coordinate axis in accordance with a transport speed of the inspection object in the direction of the one coordinate axis.

In this case, the inspection image or the inference value image and the projection image in the bar graph form are displayed on the display unit by aligning the position of each line image region in the direction of the one coordinate axis in accordance with a transport speed of the inspection object in the direction of the one coordinate axis. Accordingly, at which position in the transport direction an abnormality is detected on which inspection object among inspection objects being transported, or whether or not an abnormality is not detected at any position can be easily visually recognized from the projection image in the bar graph form having a threshold value display.

In a preferred embodiment of the present invention, (3) the display control unit may move the inspection image or the inference value image on the display unit in accordance with the transport speed of the inspection object in the direction of the one coordinate axis, and display the inspection image or the inference value image and the projection image in the bar graph form on both sides of the inspection image or the inference value image in the direction of the other coordinate axis.

In this case, in a case where the inspection image or the inference value image is displayed on the display unit by moving in accordance with the transport speed of the inspection object in the direction of the one coordinate axis, the inspection image or the inference value image and the corresponding projection image in the bar graph form are displayed on one side and the other side in the direction of the other coordinate axis. Accordingly, in a case where the inspection image or the inference value image of the inspection object is displayed by moving, the corresponding projection image in the bar graph form is displayed by moving in the same direction in accordance with the moving display of the inspection image or the inference value image, and presence or absence of an abnormality in the quality state for each inspection object can be easily visually recognized from the projection image in the bar graph form having the threshold value display.

In a preferred embodiment of the present invention, (4) the projection image generation unit may generate at least one of a first projection image in a bar graph form obtained by projecting a maximum value of the density of each of a plurality of first line image regions adjacent to each other in the direction of the one coordinate axis and present in the direction of the other coordinate axis in the inference value image to a corresponding first line image region on the one coordinate axis with a length corresponding to the maximum value of the density, or a second projection image in a bar graph form obtained by projecting a maximum value of the density of each of a plurality of second line image regions adjacent to each other in the direction of the other coordinate axis and present in the direction of the one coordinate axis in the inference value image to a corresponding second line image region on the other coordinate axis with a length corresponding to the maximum value of the density.

In this case, the first projection image is projected to the one coordinate axis of the inference value image, and the second projection image is projected to the other coordinate axis of the inference value image. Thus, the first projection image and/or the second projection image can be displayed in association with any one side in a top-to-bottom direction and/or any one side in a left-to-right direction with respect to the inspection image or the inference value image, and the presence or absence of an abnormality in the quality state or an abnormality generating part for each inspection object can be easily visually recognized from the projection image in the bar graph form having the threshold value display.

In a preferred embodiment of the present invention, (5) the display control unit may display the inspection image or the inference value image and at least one of the first projection image or the second projection image on the display unit by aligning positions in a direction of any corresponding one or each of coordinate axes for the first line image region and the corresponding first line image region and the second line image region and the corresponding second line image region.

In this case, the inspection image or the inference value image and the projection image in the bar graph form are displayed on the display unit by aligning the positions of the plurality of line image regions of the inspection image or the inference value image and the plurality of corresponding line image regions of the first projection image in the direction of the one coordinate axis, and/or displayed on the display unit by aligning the positions of the plurality of line image regions of the inspection image or the inference value image and the plurality of corresponding line image regions of the second projection image in the direction of the other coordinate axis. Accordingly, at which position an abnormality is detected on which inspection object among the inspection objects being transported, or whether or not an abnormality is not detected at any position can be easily visually recognized from the projection image in the bar graph form having the threshold value display.

In a preferred embodiment of the present invention, (6) the display control unit may move the inspection image or the inference value image on the display unit in accordance with the transport speed of the inspection object in the direction of the one coordinate axis, and display the inspection image or the inference value image and at least one of the first projection image or the second projection image in three display regions adjacent to each other in the direction of the other coordinate axis of the inspection image or the inference value image.

In this case, in a case where the inspection image or the inference value image is moved on the display unit in accordance with the transport speed of the inspection object in the direction of the one coordinate axis, the inspection image or the inference value image and at least one of the first projection image or the second projection image are displayed in three display regions adjacent to each other in the direction of the other coordinate axis. Accordingly, the inspection image or the inference value image and at least one of the first or second projection image can be displayed by moving in the direction of the one coordinate axis in synchronization while correspondingly disposing the inspection image or the inference value image and the at least one of the first or second projection image in the direction of the other coordinate axis. Even during the movement of the display, at which position an abnormality is detected on the inspection object can be easily visually recognized when the abnormality is detected.

In a preferred embodiment of the present invention, (7) the display control unit may move the inspection image or the inference value image on the display unit in accordance with the transport speed of the inspection object in the direction of the one coordinate axis, and display the inspection image or the inference value image and at least one of the first projection image or the second projection image in three display regions adjacent to each other in the direction of the other coordinate axis of the inspection image or the inference value image.

In a preferred embodiment of the present invention, (8) the display control unit may move the inspection image or the inference value image on the display unit in accordance with the transport speed of the inspection object in the direction of the one coordinate axis, and display the inspection image or the inference value image and the projection image in the bar graph form on both sides of the inspection image or the inference value image in the direction of the other coordinate axis.

In a preferred embodiment of the present invention, (9) the projection image generation unit may generate at least one of a first projection image in a bar graph form obtained by projecting a maximum value of the density of each of a plurality of first line image regions adjacent to each other in the direction of the one coordinate axis and present in the direction of the other coordinate axis in the inference value image to a corresponding first line image region on the one coordinate axis with a length corresponding to the maximum value of the density, or a second projection image in a bar graph form obtained by projecting a maximum value of the density of each of a plurality of second line image regions adjacent to each other in the direction of the other coordinate axis and present in the direction of the one coordinate axis in the inference value image to a corresponding second line image region on the other coordinate axis with a length corresponding to the maximum value of the density.

In a preferred embodiment of the present invention, (10) the display control unit may display the inspection image or the inference value image and at least one of the first projection image or the second projection image on the display unit by aligning positions in a direction of any corresponding one or each of coordinate axes for the first line image region and the corresponding first line image region and the second line image region and the corresponding second line image region.

In a preferred embodiment of the present invention, (11) the display control unit may move the inspection image or the inference value image on the display unit in accordance with a transport speed of the inspection object in the direction of the one coordinate axis, and display the inspection image or the inference value image and at least one of the first projection image or the second projection image in three display regions adjacent to each other in the direction of the other coordinate axis of the inspection image or the inference value image.

In a preferred embodiment of the present invention, (12) the display control unit may move the inspection image or the inference value image on the display unit in accordance with a transport speed of the inspection object in the direction of the one coordinate axis, and display the inspection image or the inference value image and at least one of the first projection image or the second projection image in three display regions adjacent to each other in the direction of the other coordinate axis of the inspection image or the inference value image.

### Advantage of the Invention

According to the present invention, an article inspection device that can easily visually display at which position in a transport direction a detection target spot such as an abnormality or a candidate of the detection target spot is detected, on a display screen of an inspection image, and that can also clearly show a determination reference can be provided.

### BRIEF DESCRIPTION OF THE DRAWINGS

FIG. 1 is a schematic configuration diagram of an article inspection device according to one embodiment of the present invention.

FIG. 2 is a descriptive diagram of a display and operation unit in the article inspection device for abnormality detection according to one embodiment of the present invention, illustrating a first example of an inspection image display in which an inspection image or an inference value image corresponding to the inspection image and a projection image in a bar graph form obtained by projecting the maximum value of a pixel density for each region among a plurality of line image regions present in a y-axis direction in the inference value image to an x-axis are disposed in a top-to-bottom direction on a display screen.

FIG. 3 is a descriptive diagram of the display and operation unit in the article inspection device according to one embodiment of the present invention, illustrating a second example of the inspection image display in which the inspection image or the inference value image corresponding to the inspection image and a projection image in a bar graph form obtained by projecting the maximum value of a pixel density for each region among a plurality of line image regions present in an x-axis direction in the inference value image to the y-axis are disposed in a left-to-right direction on the display screen.

FIG. 4 is a descriptive diagram of the display and operation unit in the article inspection device according to one embodiment of the present invention, illustrating a third example of the inspection image display in which the inspection image or the inference value image corresponding to the inspection image and first and second projection images obtained by projecting the maximum values of the pixel density for each region among the plurality of line image regions present in the x-axis direction and the y-axis direction in the inference value image to the x-axis and the y-axis, respectively, are disposed in association with the top-to-bottom direction and the left-to-right direction on the display screen.

FIG. 5 is a descriptive diagram of the display and operation unit in the article inspection device according to one embodiment of the present invention, illustrating a fourth example of the inspection image display in which the inspection image or the inference value image corresponding to the inspection image and the first and second projection images obtained by projecting the maximum values of the pixel density for each region in the plurality of line image regions present in the x-axis direction and the y-axis direction in the inference value image to the x-axis and the y-axis, respectively, are disposed in three display regions in the top-to-bottom direction on the display screen.

FIG. 6 is a descriptive diagram of the display and operation unit in the article inspection device of an object detection system according to another embodiment of the present invention, illustrating one example of the inspection image display in which the inspection image, a rectangle surrounding a shape defect part in the inspection image as a detection object, and the first and second projection images obtained by projecting the maximum values of the pixel density for each region among the line image regions present in the x-axis direction and the y-axis direction in the inspection image in the rectangle to the x-axis and the y-axis, respectively, and displaying the maximum values together with a threshold value for defect determination are displayed by moving in synchronization in the top-to-bottom direction or the left-to-right direction while being disposed in association with the top-to-bottom direction and the left-to-right direction on the display screen.

FIG. 7 is a descriptive diagram of the display and operation unit in the article inspection device of the object detection system according to the other embodiment of the present invention, illustrating a display state after adjusting the threshold value for defect determination in the first and second projection images to a higher confidence side from that illustrated in FIG. 6 while using the same inspection image as the one example of the inspection image display illustrated in FIG. 6.

### BEST MODE FOR CARRYING OUT THE INVENTION

Hereinafter, embodiments of the present invention will be described with reference to the drawings.

### One Embodiment

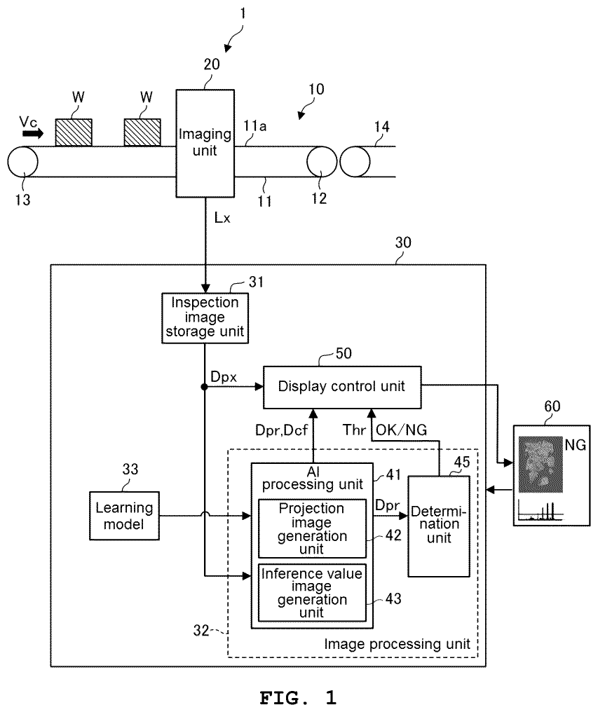

FIGS. 1 to 5 illustrate an article inspection device according to one embodiment of the present invention.

First, a configuration will be described.

As illustrated in FIG. 1, an article inspection device 1 of the present embodiment is provided with a transport unit 10 that transports an article W which is an inspection object, an imaging unit 20 that images the article W being transported, a control unit 30 for main control including control of the transport unit 10 and the imaging unit 20, and a display and operation unit 60 such as a touch panel. The article inspection device 1 detects image data corresponding to an X-ray transmission amount distribution while emitting, for example, an X-ray to the article W transported by the transport unit 10 using a conveyor, via the imaging unit 20 and inspects a quality state of the article W based on the image data. Here, the quality state is appropriateness of quality or a physical quantity required for the article W as a product. For example, the quality state is presence or absence of a contained foreign object, presence or absence of a missing product, appropriateness of a shape, a size, a packaging state, and the like of contents, or a distribution of a density, a thickness, a volume, or a mass.

The transport unit 10 is a conveyor that is obtained by winding a loop-shaped transport belt 11 around a driving-side transport roller 12 and a driven-side transport roller 13 and that transports, to the right in FIG. 1, the article W sequentially input into an upper traveling section 11a of the transport belt 11 from an upstream side and discharges the article W to a conveyor 14 on a downstream side through an imaging section of the imaging unit 20. The transport unit 10 is supported by a casing (not illustrated).

The imaging unit 20 (not illustrated in detail) includes, for example, an X-ray generator (an X-ray source) that generates an X-ray in a predetermined energy band transmitted through the article W transported by the transport unit 10, and an X-ray detector disposed immediately below the upper traveling section 11a of the transport belt 11. The imaging unit 20 is not limited to acquiring an inspection image Dpx by emitting the X-ray to the article W and, for example, may use an exterior or transmission camera image using a near infrared ray (NIR) as the inspection image or use a color image obtained by imaging an exterior of the article using other types of light such as visible light as the inspection image.

The X-ray generator of the imaging unit 20 generates the X-ray having a wavelength and an intensity corresponding to a tube current and a tube voltage of a well-known X-ray tube and can emit a fan beam-shaped X-ray in a main observation direction orthogonal to an article transport direction of the transport unit 10, to the article W on the transport belt 11 through an X-ray window portion of an envelope (not illustrated in detail).

The X-ray detector (not illustrated in detail) of the imaging unit 20 is configured with an X-ray line sensor camera that is obtained by disposing a detection element consisting of a scintillator as a phosphor and a photodiode or a charge-coupled element at a predetermined pitch in an array in a width direction of a transport path of the transport unit 10 and that outputs a detection signal Lx corresponding to an X-ray transmission amount with a predetermined resolution. The X-ray detector is disposed at a predetermined position in the transport direction corresponding to an X-ray emission position from the X-ray generator.

That is, the imaging unit 20 can detect the X-ray emitted from the X-ray generator and transmitted through the article W for each predetermined transmission region corresponding to the detection element, convert the X-ray into an electric signal corresponding to a transmission amount of the X-ray, and output an X-ray detection signal for generating an X-ray transmission image in which a direction of transmission of the X-ray is an observation direction. Here, while the X-ray emitted from the X-ray generator or the X-ray detected by the X-ray detector has a certain radiation quality (energy and a wavelength) specified in accordance with quality of the article W, a so-called dual-energy or multi-energy X-ray image may also be generated using a plurality of types of X-rays having different radiation qualities.

The control unit 30 has a function of transport control means for controlling a transport speed, a transport interval, and the like of the article W for the transport belt 11 in the transport unit 10, and a function of inspection control means for controlling an X-ray emission intensity and an emission period in the imaging unit 20 or controlling an X-ray detection cycle in the X-ray line sensor of the X-ray detector, a detection period of each article W, and the like corresponding to the transport speed of the article W.

The control unit 30 includes an inspection image storage unit 31, an image processing unit 32, and a learning model 33 as main means for exhibiting the function of the inspection control means, and further includes a display control unit 50 for display control of the display and operation unit 60.

The inspection image storage unit 31 sequentially acquires the X-ray detection signal from the X-ray detector of the imaging unit 20, temporarily stores the image data indicating the X-ray transmission amount distribution of each article W in a memory, and outputs the image data as image data of the inspection image Dpx.

The image processing unit 32 sequentially acquires the image data of the inspection image Dpx output from the inspection image storage unit 31, executes image analysis processing for extracting a global feature or a local feature of the image (for example, extracting a feature value of a local region based on a pixel value or a brightness gradient or extracting a frequency feature value of the whole image such as a spatial frequency spectrum) through predetermined preprocessing or filter processing, and executes first inspection image processing that enables whether a quality state of the article W is normal or not normal to be determined using a predetermined image processing algorithm based on a result of the image processing. Here, the predetermined filter processing is filter processing of detecting or highlighting an image feature (for example, an edge or a blob) for which the quality state tends to deviate from a normal state, that is, a degree of the quality state is different from normality, using the above predetermined image processing algorithm.

The image processing unit 32 also has a function of second inspection image processing of determining whether the quality state of the article W is normal or not normal using confidence, by exhibiting, in addition to the above function of executing the first inspection image processing, a function of cooperating with the learning model 33 to perform classification or abnormality detection (anomaly detection) through deep learning based on the inspection image of the article W acquired by the inspection image storage unit 31 or on the inspection image after the above predetermined filter processing. Here, the classification is processing of performing image class classification through which, for example, an article type of the inspection object can be specified by extracting a feature and learning a decision boundary in the input image. The abnormality detection (anomaly detection) is processing of detecting an abnormal part, for example, a partial loss of contents of the inspection object or an irregularity deviating from a normal range in the input image as an abnormality.

The learning model 33 is a neural network of multiple layers for causing the image processing unit 32 to exhibit the classification function or the abnormality detection function through deep learning based on the above inspection image or the inspection image after the predetermined filter processing.

In the learning model 33, in a learning phase, learning including learning a feature of an image of a normal product using only image data of a normal product image not having an abnormality such as a foreign object as an image dataset for learning, inputting a predetermined number (for example, approximately 1000) of images of the normal product for learning into the learning model 33, and adjusting a parameter such as a weight between layers of the neural network, for example, a weight of weighting in any j-th neuron of a hidden layer (an intermediate layer) with respect to any i-th neuron of an input layer and a weight of weighting in any k-th neuron of an output layer with respect to the any j-th neuron of the hidden layer (may include a threshold value) is performed.

A dataset of the normal product image used for learning of the learning model 33 is, for example, a dataset in which an OK tag is automatically added to a sample image of the normal product as annotation information for the anomaly detection. Alternatively, an annotation task of assigning a score indicating that a degree of not being normal is high to normal products closest to an abnormal product in shape, disposition, or the like, for example, a normal product having a visually unnoticeable loss or an irregularity close to a normal limit.

In the learning model 33, the parameter such as the weight between the layers of the multiple layers is adjusted for the image data of each normal product image for learning such that an output value of the neural network is distributed within a normal attribute region in which a main feature value of each normal product image is distributed in a feature space based on the above global feature or local feature of the image for each determination pixel region of a predetermined number of pixels of the inspection image that is a unit for processing of inspection determination, for example, for each pixel (one pixel).

In an inference phase, in a case where the image data of the inspection image Dpx of the normal product is input from the inspection image storage unit 31, the trained learning model 33 after adjusting the parameter specifies, in the normal attribute region in which the normal product image for learning is distributed, the inspection image and a center of distribution or a distribution pattern of the feature value of each determination pixel region in the feature space based on the above global feature or local feature of the image in accordance with the output value of the neural network.

In order to execute the function of the second inspection image processing for exhibiting the above function of the classification or the abnormality detection through deep learning in cooperation with the learning model 33, the image processing unit 32 includes an AI processing unit 41 that exhibits the function of the second inspection image processing, and a determination unit 45 that comprehensively determines whether the quality state of the article W is normal or not normal based on a result of the first inspection image processing and a result of the second inspection image processing performed by the AI processing unit 41 or using a result of effective inspection image processing in accordance with the article type.

The AI processing unit 41 is configured to exhibit the classification function or the abnormality detection function using the learning model 33 based on the above inspection image or the inspection image after the predetermined filter processing, and includes a projection image generation unit 42 and an inference value image generation unit 43.

In a case where the image data of the inspection image Dpx is input from the inspection image storage unit 31, the inference value image generation unit 43, for each of the plurality of determination pixel regions of the predetermined number of pixels constituting the inspection image, compares the above distribution, in the feature space, of the output value of the learning model 33 for each piece of the image data with the learned center of distribution, distribution pattern, or the like of a plurality of normal product images in the same feature space for the corresponding determination pixel region, and outputs, as the confidence, an inference value of a probability with which the distribution pattern of the feature value of the input image is not distributed in the normal attribute region.

More specifically, the inference value image generation unit 43 is configured to include a neural network for image generation corresponding to the neural network of the multiple layers of the learning model 33, for example, a convolutional autoencoder using a feature parameter, a weighting coefficient, or the like learned by the learning model 33. The autoencoder has a property such that, in a case where the image data of the inspection image Dpx is input from the inspection image storage unit 31, an error in reconstructing a loss or an abnormal part in the image is higher in a case where image data of a product that is not normal is used than in a case where the image data of the normal product is input. Accordingly, the reconstruction error of the normal product image in the inference value image generation unit 43 can be said to be a value indicating the degree of not being normal for the distribution pattern of the feature value of the input image.

Therefore, the inference value image generation unit 43 calculates and outputs the degree of not being normal, that is, the inference value of the probability indicating that the above distribution of the feature value in the feature space tends to deviate from the normal attribute region, as the confidence for each determination pixel region, for example, for each pixel, for the plurality of determination pixel regions of the predetermined number of pixels constituting the inspection image Dpx based on the reconstruction error of the image for each pixel reconstructed by the autoencoder with respect to the image data of the inspection image Dpx from the inspection image storage unit 31.

The inference value image generation unit 43 is further configured to generate image data of a two-dimensional shade image obtained using the output value of the confidence as a density of the image, as image data of an inference value image Dcf based on each output value of the confidence corresponding to the plurality of determination pixel regions of the inspection image Dpx. Here, the output value of the confidence may be used as the density for each pixel (a pixel density). However, in a case where a range of possible values of the output value of the confidence is significantly different from a range of possible values of a pixel density designation value, a value of the density corresponding to the output value of the confidence may be obtained using a conversion formula. For example, in a case where a range Dw of the possible values of the output value of the confidence is 0 to 100 (Dw=100) and a range Cw of the pixel density designation value is 0 to 255 (Cw=255), the conversion formula in Formula [1] below can be used.

$$Pixel Density = Confidence \times Cw / Dw \qquad [ 1 ]$$

In a case where the inspection image is a color image, shades of the two-dimensional shade image may be pixel values that cause a change in shades for only a specific color component (any of R, G, or B). In a case where the learning model 33 also has a function of an object detection model, the learning model 33 may learn whether an object or a background is present inside the rectangle on the image and, in a case where an object is present, be trained to reduce an error between a category of the object in the rectangle and a correct answer label. In this case, the inference value image generation unit 43 can have a network configuration of two tiers including a tier in which a feature map of the input image is acquired, and a tier in which a plurality of rectangles are generated on the feature map, and a rectangle candidate region obtained by calculating an inference of the classification in each rectangle and an inference error is suggested.

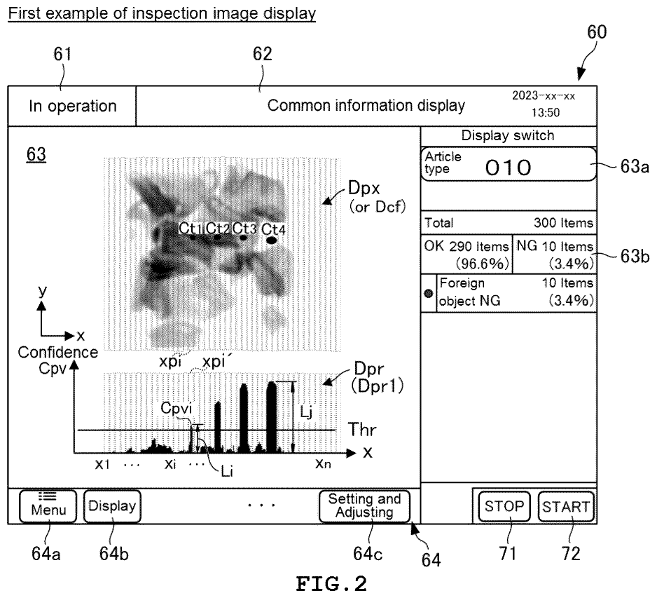

In a case where the image data of the inference value image Dcf, which is the image data of the two-dimensional shade image, is input from the inference value image generation unit 43, the projection image generation unit 42, as illustrated in FIG. 2, generates a projection image Dpr in a bar graph form having a length corresponding to a maximum value Cpv of the density of the confidence in each corresponding line image region xpi′ by projecting the maximum value Cpv of the density corresponding to the confidence for each line image region xpi to one coordinate axis x for a plurality of line image regions xpi adjacent to each other in a direction of the one coordinate axis x and present in a direction of another coordinate axis y in the inference value image Dcf, and outputs the projection image Dpr to the display control unit 50.

The display control unit 50 moves the inspection image Dpx or the inference value image Dcf in an x-axis direction, which is one side in a left-to-right direction, in FIG. 2 in an inspection image display region 63 of the display and operation unit 60 in accordance with a transport speed Vc of the article W in the direction of the one coordinate axis x, and displays the inference value image Dcf and the projection image Dpr in the bar graph form to be arranged in a y-axis direction, which is the other coordinate axis out of both coordinate axes x and y of the inference value image Dcf, while having the x axes, which are the one coordinate axis, parallel to each other.

That is, the display control unit 50 displays the inspection image Dpx or the inference value image Dcf at the same position on an upper side, which is one side in the y-axis direction, in FIG. 2 as an observation image from above, and displays the projection image Dpr on a lower side, which is the other side in the y-axis direction, in FIG. 2 as an observation image such that the distribution of the maximum value Cpv (simply displayed as the confidence in the drawing) of the confidence among the plurality of determination pixel regions of each line image region xpi can be observed from the front of the inspection image Dpx or the inference value image Dcf.

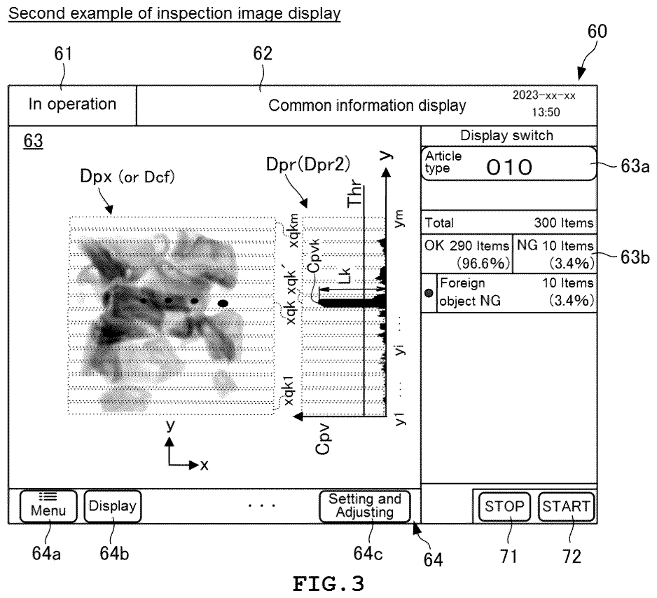

The projection image generation unit 42 is configured to generate at least one of a first projection image Dpr1 having a length Li corresponding to a maximum value Cpvi of the confidence in each corresponding first line image region xpi′ by projecting the maximum value Cpv of the confidence (a density corresponding to the inference value of the confidence; simply referred to as the confidence Cpv in FIGS. 2 to 5) corresponding to the pixel of the maximum density for each first line image region xpi to the x-axis, which is the one coordinate axis, for a plurality of first line image regions xpi adjacent to each other in an x direction and present in a y direction in the inspection image Dpx or the inference value image Dcf, or a second projection image Dpr2 having a length Lk (a case of Lk=Lj is illustrated in FIGS. 3 to 5) corresponding to the maximum value Cpv of the confidence in each corresponding second line image region xqk by projecting the maximum value Cpv of the confidence for each second line image region xqk to the y-axis, which is the other coordinate axis, for a plurality of second line image regions xqk adjacent to each other in the y direction and present in the x direction in the inspection image Dpx or the inference value image Dcf.

As illustrated in a first example to a fourth example of the inspection image display in FIGS. 2 to 5, the display control unit 50 displays, for example, the inspection image Dpx in which the article W is easily identified, on the display and operation unit 60 and displays at least one of the first projection image Dpr1 or the second projection image Dpr2 (Dpr1 and/or Dpr2) obtained from the inference value image Dcf at the same position as the inspection image Dpx displayed here by moving the at least one of the first projection image DPr1 or the second projection image Dpr2 in accordance with passage of the article W through the imaging section (including a temporary stoppage for a predetermined time) while aligning a position xi in the x-axis direction and/or a position yi in the y-axis direction in any corresponding one or each of the coordinate axes for the first line image region xpi of the inspection image Dpx or the inference value image Dcf and the second line image region xqk of the inference value image Dcf.

That is, in the first example of the inspection image display illustrated in FIG. 2, in the inspection image display region 63 of the display and operation unit 60, each first line image region xpi′ of the first projection image Dpr1 is displayed by moving in synchronization with each other to be always displayed on the same straight line as each corresponding first line image region xpi of the inspection image Dpx (or the inference value image Dcf; the same applies to FIGS. 2 to 5).

In the second example of the inspection image display illustrated in FIG. 3, in the inspection image display region 63 of the display and operation unit 60, the second line image region xqk′ of the second projection image Dpr2 is displayed by moving in the x direction (or in this case, the y direction) in synchronization with each other to be always displayed on the same straight line as each corresponding second line image region xqk of the inspection image Dpx. A number m and a width (a width in the y direction) of the second line image region xqk′ may be the same as or different from a number n and a width (a width in the x direction) of the first line image region xpi′, and may change depending on an image size or a display size of the inspection image Dpx. Thus, in each example of the inspection image display from FIG. 3, the width of each line image region is illustrated to be larger than the example illustrated in FIG. 2.

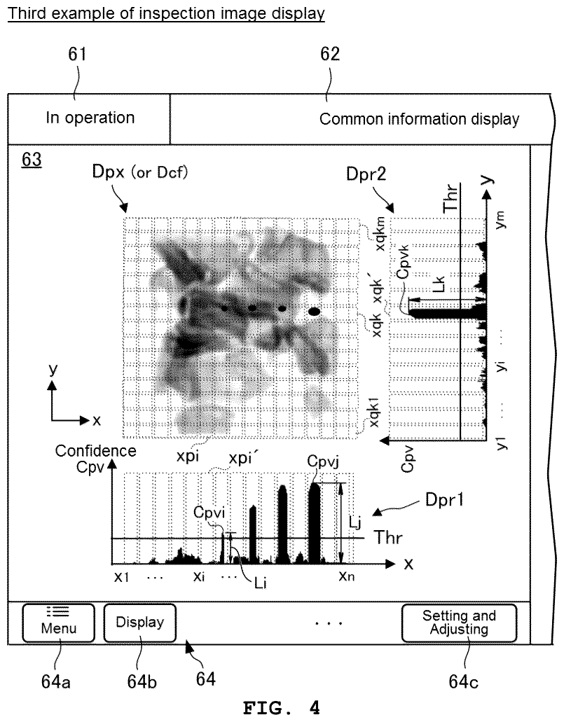

In the third example of the inspection image display illustrated in FIG. 4, in the inspection image display region 63 of the display and operation unit 60, each first line image region xpi′ of the first projection image Dpr1 is displayed by moving in the x direction in synchronization with each other to be always displayed on the same straight line as each corresponding first line image region xpi of the inspection image Dpx, and each second line image region xqk′ of the second projection image Dpr2 is displayed by moving in the x direction (or in this case, the y direction) in synchronization with each other to be always displayed on the same straight line as each corresponding second line image region xqk of the inference value image Dcf.

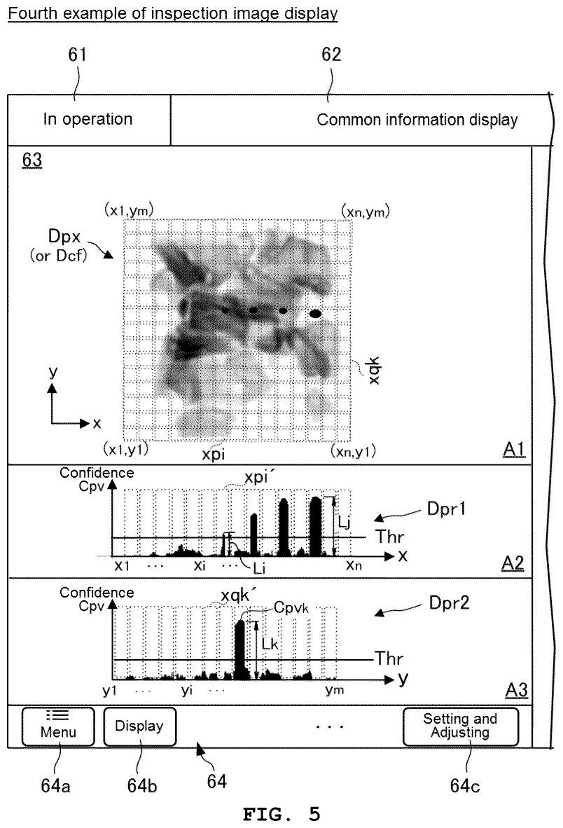

Alternatively, as illustrated in FIG. 5 as the fourth example of the inspection image display, in the inspection image display region 63 of the display and operation unit 60, the inspection image Dpx is displayed by moving in a display region A1 among three display regions A1, A2, and A3 adjacent to each other in the y-axis direction, together with descriptive diagrams of the x and y directions of the coordinate axes or further with an appropriate grid display. In the display region A2 immediately below the display region A1 among the three display regions A1, A2, and A3, each first line image region xpi′ of the first projection image Dpr1 is displayed by moving in the x direction in synchronization with each other to be always displayed on the same straight line as each corresponding first line image region xpi of the inspection image Dpx, and each second line image region xqk′ of the second projection image Dpr2 having a different observation direction from the first projection image Dpr1 is displayed by moving in the x direction in synchronization with each other to be always displayed on the same straight line as each first line image region xpi′ of the first projection image Dpr1.

That is, the display control unit 50 may move the inspection image Dpx or the inference value image Dcf to one side in the left-to-right direction in the inspection image display region 63 of the display and operation unit 60 in accordance with the transport speed of the article W in the x-axis direction, and may display the inspection image Dpx or the inference value image Dcf and at least one of the first projection image Dpr1 or the second projection image Dpr2 in the three display regions A1, A2, and A3 adjacent to each other in the y-axis direction of the inspection image Dpx or the inference value image Dcf.

In the display and operation unit 60, the inspection image Dxp or the inference value image Dcf is displayed in the wide inspection image display region 63 below an inspection state display region 61 and a common information display region 62, and an article type number corresponding to the currently set article type, the most recent inspection determination result of the inspection article W displaying main inspection information, a total inspection result for the set article type, and the like are displayed in inspection information display regions 63a and 63b that are partial regions on the right of the inspection image display region 63.

In an operation unit region 64 below the inspection image display region 63, a menu button 64a, a display switch button 64b, a setting and adjusting button 64c, and the like are disposed in this order from the left as various operation buttons constituting an operation input function unit of the display and operation unit 60. A stop button 71 (STOP in the drawing) for making a request to stop inspection and a start button 72 (START in the drawing) for making a request to start an inspection operation are disposed on the right of the operation unit region 64.

In the projection image Dpr illustrated in FIGS. 2 and 3 or the first projection image Dpr1 and the second projection image Dpr2 illustrated in FIGS. 4 and 5, a determination threshold value Thr for determining whether the quality state of the article W is normal or not normal via the determination unit 45 based on the result of the first inspection image processing performed by the image processing unit 32 and the result of the second inspection image processing performed by the AI processing unit 41 is displayed parallel to the x-axis or the y-axis which is a projection axis.

The determination threshold value Thr is generated by the projection image generation unit 42 and is automatically set in advance such that, for example, in a case where a pseudo-defective product to which a plurality of foreign object samples Ct1, Ct2, Ct3, and Ct4 having different spherical diameters illustrated in FIG. 2 are attached is imaged by the imaging unit 20, and the image processing unit 32 acquires the image data of the inspection image Dpx from the inspection image storage unit 31, the maximum value Cpvi of the confidence (the density) in the specific first line image region xpi corresponding to the foreign object sample Ct1 is determined not to be normal by the determination threshold value Thr or corresponds to the result of the first inspection image processing using the foreign object sample Ct1 having the smallest spherical diameter among the plurality of foreign object samples Ct1, Ct2, Ct3, and Ct4 as a sample corresponding to the smallest foreign object to be detected with detection accuracy required for the article W or to other relatively less significant abnormal parts.

The determination threshold value Thr can be finely adjusted in a direction of increasing or decreasing the confidence Cpv by operating the setting and adjusting button 64c with reference to display content of the inspection image Dxp or the inference value image Dcf and the first projection image Dpr1 and/or the second projection image Dpr2 displayed in the inspection image display region 63 of the display and operation unit 60.

In each of the projection image Dpr, the first projection image Dpr1, and the second projection image Dpr2 displayed in the inspection image display region 63 of the display and operation unit 60, a display range in the direction of increasing or decreasing the confidence (the density) can be appropriately set in accordance with, for example, a range of use of a display image density in the display and operation unit 60 (corresponding to a brightness range from the minimum brightness to the maximum brightness) or a range of a background image density and a display image density of the article W in the inspection image Dxp or the inference value image Dcf or further in accordance with a difference in display aspects such as the first to fourth examples of the inspection image display.

Next, actions will be described.

In the present embodiment configured as described above, first, in the learning phase of the learning model 33, learning including learning the feature of the normal product image using only the image data of the normal product image not having an abnormality such as a foreign object as the image dataset for learning, and adjusting the parameter such as the weight between the layers of the neural network constituting the learning model 33 is performed.

After the parameter is adjusted, the image data of the inspection image Dpx of the normal product is input from the inspection image storage unit 31 in the inference phase of the trained learning model 33.

For example, first, in order to set an inspection condition of an inspection target article type, the determination threshold value Thr is automatically set such that, in a case where the pseudo-defective product to which the plurality of foreign object samples Ct1, Ct2, Ct3, and Ct4 having different spherical diameters are attached is imaged by the imaging unit 20, and the image processing unit 32 acquires the image data of the inspection image Dpx from the inspection image storage unit 31, the maximum value Cpvi of the confidence (the density) in the specific first line image region xpi in the inference value image Dcf corresponding to the foreign object sample Ct1 having the smallest spherical diameter among the plurality of foreign object samples Ct1, Ct2, Ct3, and Ct4 exceeds the determination threshold value Thr and is determined not to be normal.

Alternatively, the determination threshold value Thr is finely adjusted in the direction of increasing or decreasing the confidence Cpv by causing an operator to operate the setting and adjusting button 64c with reference to the display content of the inspection image Dxp or the inference value image Dcf and the first projection image Dpr1 and/or the second projection image Dpr2 displayed in the inspection image display region 63 of the display and operation unit 60.

Next, the article W, which is the inspection object, is imaged at a predetermined transport interval or in units of transport distances, and the image processing unit 32 sequentially acquires the imaging data of a plurality of input articles W as the image data of the inspection image Dpx from the inspection image storage unit 31.

At this point, in the inference value image generation unit 43 of the image processing unit 32, the inference value of the degree of not being normal is calculated as the confidence for each determination pixel region, for example, for each pixel, for the plurality of determination pixel regions of the predetermined number of pixels constituting the inspection image Dpx based on the reconstruction error of the image for each pixel reconstructed by the autoencoder with respect to the image data of the inspection image Dpx from the inspection image storage unit 31. The image data of the two-dimensional shade image obtained from the inference value image generation unit 43 using the output value of the confidence as the density of the image is generated as the image data of the inference value image Dcf based on each output value of the confidence corresponding to the plurality of determination pixel regions of the inspection image Dpx.

In a case where the image data of the inference value image Dcf, which is the image data of the two-dimensional shade image, is output from the inference value image generation unit 43, the projection image generation unit 42, for example, as illustrated in FIG. 2, generates the projection image Dpr in the bar graph form displaying the maximum value Cpv as the confidence Cpv in the corresponding line image region xpi′ based on the image data of the inference value image Dcf by projecting the maximum value Cpv of the density corresponding to the confidence of the line image region xpi to the one coordinate axis x for each line image region xpi in the inference value image Dcf, and outputs the projection image Dpr to the display control unit 50.

In a case where the image data of the inference value image Dcf is output from the inference value image generation unit 43, the determination unit 45 sets the determination threshold value Thr for determining whether the quality state of the article W is normal or not normal based on the result of the first inspection image processing performed by the image processing unit 32 and the result of the second inspection image processing performed by the AI processing unit 41.

At this point, the display control unit 50 displays the inspection image Dpx or the inference value image Dcf by moving the inspection image Dpx or the inference value image Dcf in the x-axis direction in FIG. 2 in the inspection image display region 63 of the display and operation unit 60 in accordance with the transport speed Vc of the article W in the direction of the one coordinate axis x, and displays the inference value image Dcf and the projection image Dpr in the bar graph form on which a line corresponding to the determination threshold value Thr is added, by moving the inference value image Dcf and the projection image Dpr in the y-axis direction in synchronization with each other within the same display range in the x direction while having the x axes parallel to each other.

In the present embodiment, the inference value related to the quality state of the article W is obtained as the confidence for each unit region of the predetermined number of pixels in the inspection image Dpx, and the two-dimensional shade image obtained using the inference value as the density is generated as the inference value image Dcf. The plurality of line image regions xpi adjacent to each other in the x-axis direction, which is the one coordinate axis, and present in the y-axis direction in the inference value image Dcf are displayed as a projection diagram by sequentially projecting the maximum pixel value Cpv of each line image region xpi to any one coordinate axis in association with the transport direction or the like of the article W.

Accordingly, it is easy to instantly visually recognize at which position in the transport direction on the article W or at which position in a line scanning direction an abnormality or a foreign object is detected. Consequently, at which position in the x direction, which is the transport direction, a detection target spot such as an abnormality or a candidate of the detection target spot is detected can be easily visually displayed in the inspection image display region 63, and a determination reference can also be clearly shown as the determination threshold value Thr.

In the present embodiment, at which position in the transport direction an abnormality is detected on which article W among the articles W being transported, or whether or not an abnormality is not detected at any position can be easily visually recognized from the projection image Dpr in the bar graph form having a threshold value display.

In the present embodiment, in a case where the inspection image Dpx or the inference value image Dcf is displayed by moving to one side in the left-to-right direction in accordance with the transport speed Vc of the article W in the x-axis direction on the display and operation unit 60, the inspection image Dpx or the inference value image Dcf and the corresponding projection image Dpr in the bar graph form are displayed on the upper side and the lower side (one side and the other side) in the y-axis direction. Thus, the presence or absence of an abnormality in the quality state for each article W can be easily visually recognized from the projection image Dpr in the bar graph form having the threshold value display. In addition, since the corresponding projection image Dpr is displayed by moving in the same direction in synchronization with the moving display of the inspection image Dpx or the inference value image Dcf of the article W, a position of an abnormal spot in the quality state can be visually recognized more easily and accurately.

In the present embodiment, the projection image generation unit 42 generates at least one of the first projection image Dpr1 obtained by projecting the maximum value Cpv of the density of the inference value for each region to the x-axis for the plurality of first line image regions xpi adjacent to each other in the x-axis direction and present in the y-axis direction in the inference value image Dcf, or the second projection image Dpr2 obtained by projecting the maximum value Cpv of the density of the inference value for each region to the y-axis for the plurality of second line image regions xqk adjacent to each other in the y-axis direction and present in the x-axis direction in the inference value image Dcf. Accordingly, the first projection image Dpr1 and/or the second projection image Dpr2 can be displayed in association with any one side in a top-to-bottom direction and/or any one side in the left-to-right direction with respect to the inspection image Dpx or the inference value image Dcf, and the presence or absence of an abnormality in the quality state or an abnormality generating part for each article W can be easily visually recognized from the projection image Dpr in the bar graph form having the threshold value display.

In the present embodiment, the display control unit 50 displays the inspection image Dpx or the inference value image Dcf and at least one of the first projection image Dpr1 or the second projection image Dpr2 on the display and operation unit 60 by aligning positions in the direction of the corresponding x-axis or y-axis or in the direction of each coordinate axis for each first line image region xpi and the corresponding first line image region xpi′ and each second line image region xqk and the corresponding second line image region xqk′. Accordingly, at which position an abnormality is detected on which article W among the articles W being transported, or whether or not an abnormality is not detected at any position can be further easily visually recognized from timely display switching of any of the first projection image Dpr1 or the second projection image Dpr2, simultaneous bidirectional projection display information, and the like.

In the present embodiment, in a case where the inspection image Dpx or the inference value image Dcf is moved to one side in the left-to-right direction on the display and operation unit 60 in accordance with the transport speed of the article W in the x-axis direction, at least one of the first or second projection image Dpr1 or Dpr2 can be displayed by moving in the x-axis direction in synchronization while correspondingly disposing the at least one of the first or second projection image Dpr1 or Dpr2 in the y-axis direction with respect to the inspection image Dpx or the inference value image Dcf. Accordingly, even during the movement of the display, at which position an abnormality is detected on the article W can be easily visually recognized when the abnormality is detected, and a display region of the image displayed by moving can be sufficiently secured in a moving direction.

According to the present embodiment, the article inspection device 1 that can easily visually display at which position in the transport direction the detection target spot such as an abnormality or the candidate of the detection target spot is detected, on the display screen of the inspection image Dpx, and that can also clearly show the determination reference can be provided.

### Other Embodiments

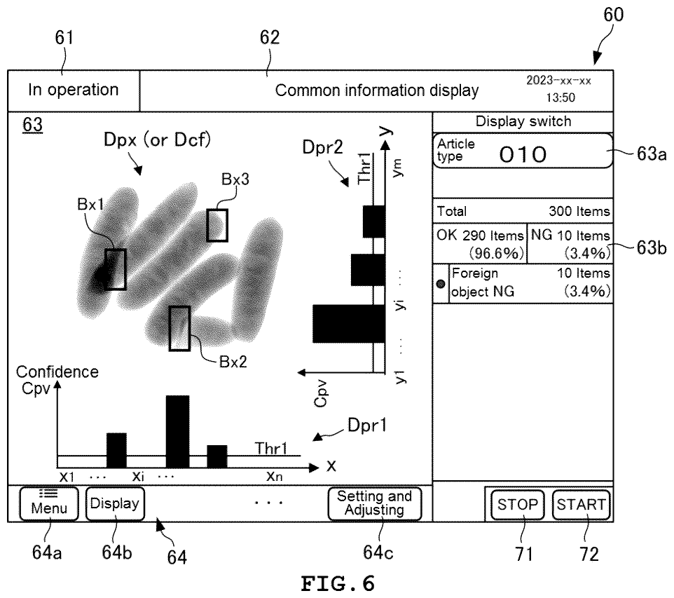

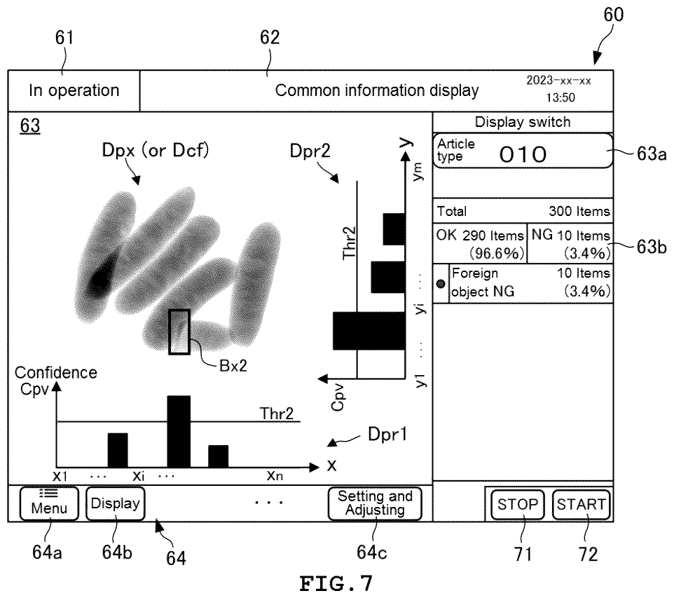

FIGS. 6 and 7 illustrate examples of the inspection image display in the article inspection device according to other embodiments of the present invention.

The article inspection device of the present embodiment has substantially the same device configuration as the article inspection device 1 of the above embodiment. Thus, the same reference numerals as one embodiment illustrated in FIG. 1 will be used for configurations similar to the article inspection device 1 of one embodiment to avoid duplicate descriptions, and differences from one embodiment will be described below.

In the present embodiment, the learning model 33 is configured to also have the function of the object detection model, and the control unit 30 exhibits a function of object detection using the functions of the AI processing unit 41, the projection image generation unit 42, and the inference value image generation unit 43 of the image processing unit 32 and the function of the determination unit 45.

That is, the inference value image generation unit 43 calculates the inference value of the degree of not being normal as the confidence for each determination pixel region, for example, for each pixel, for the plurality of determination pixel regions of the predetermined number of pixels constituting the inspection image Dpx based on the reconstruction error of the image for each pixel reconstructed by the autoencoder with respect to the image data of the inspection image Dpx from the inspection image storage unit 31. However, in the present embodiment, a rectangle illustrated in FIGS. 6 and 7, here, rectangles Bx1, Bx2, and Bx3, is further displayed on the screen of the display and operation unit 60 in accordance with a magnitude relationship between the confidence and the determination threshold value Thr set by the determination unit 45.

For the object detection, in the learning phase of the learning model 33, for example, learning including finding whether or not each of the plurality of determination pixel regions of the predetermined number of pixels constituting the inspection image Dpx is to be set as a candidate of the rectangle (a bounding box; here, includes information about a position, a class, and the confidence), determining whether an object or a background is present in the rectangle, specifying, in a case where an object is present, a rectangle candidate region for a replayed image of the object in the rectangle by calculating an error between a category of the object in the rectangle and a correct answer label, and reducing the error is performed. Here, a shape of the bounding box surrounding a target range is a general rectangle but may be any shape including a rectangle.

In the inference phase, the inference value image generation unit 43 acquires the feature map of the input image from the inspection image storage unit 31, generates a plurality of rectangles on the feature map, and executes inference of the classification as to whether an object or a background is present in each rectangle and calculation of an inference error (for example, the above reconstruction error) of the object. The image processing unit 32 and the display control unit 50 first display a plurality of rectangle candidate regions exceeding a sufficiently small first threshold value Thr1 (corresponding to a significant pixel density value exceeding 0) initially set in advance, for example, a sufficient number of candidates of the rectangle such as three rectangle candidate regions Bx1, Bx2, and Bx3 illustrated in FIG. 6. Then, in order to perform inspection with higher accuracy, for example, an operator skilled in visually identifying a shape defect or the like on the inspection image Dpx or the inference value image Dcf manually adjusts the threshold value to an appropriate second threshold value Thr2 higher than the first threshold value Thr1 so that, in a case where a shape defect part to be detected is present, the rectangle candidate region Bx2 surrounding the shape defect part can be accurately displayed, as illustrated in FIG. 7. The second threshold value Thr2 may be configured to be automatically set in accordance with required detection accuracy so that a user can effectively check appropriateness of the threshold value setting from a change in screen display content on the display and operation unit 60 as a change in an object detection spot.

Even in the present embodiment, the inference value related to the quality state of the article W is obtained as the confidence for each unit region of the predetermined number of pixels in the inspection image Dpx, and the two-dimensional shade image obtained using the inference value as the density is generated as the inference value image Dcf. The plurality of line image regions xpi adjacent to each other in the x-axis direction, which is the one coordinate axis, and present in the y-axis direction in the inference value image Dcf are displayed as a projection diagram as the first projection image Dpr1 and the second projection image Dpr2 by projecting the maximum pixel value Cpv of each line image region xpi to each of the x-axis and the y-axis, which are the one coordinate axis and the other coordinate axis, in association with the transport direction or the like of the article W.

Accordingly, it is easy to instantly visually recognize at which position in the transport direction on the article W or at which position in the line scanning direction an abnormality or a foreign object is detected. Consequently, at which position in the x direction, which is the transport direction, the detection target spot such as an abnormality or the candidate of the detection target spot is detected can be easily visually displayed in the inspection image display region 63, and the determination reference can also be clearly shown as the determination threshold values Thr1 and Thr2.

In the present embodiment, at which position in the transport direction an abnormality is detected on which article W among the articles W being transported, or whether or not an abnormality is not detected at any position can be easily visually recognized from the first and second projection images Dpr1 and Dpr2 having the threshold value display.

As described above, in the present invention, the article inspection device that can easily visually display at which position in the transport direction the detection target spot such as an abnormality or the candidate of the detection target spot is detected, on the display screen of the inspection image, and that can also clearly show the determination reference can be provided. The present invention is effective for all article inspection devices that inspect the quality state of the article using the inspection image obtained by imaging the inspection object and the trained model.

### DESCRIPTION OF REFERENCE NUMERALS AND SIGNS

1: Article inspection device
10: Transport unit
11: Transport belt
11a: Upper traveling section
12: Transport roller
13: Transport roller
14: Conveyor (rear conveyor)
20: Imaging unit
30: Control unit
31: Inspection image storage unit
32: Image processing unit
33: Learning model
41: AI processing unit
42: Projection image generation unit
43: Inference value image generation unit
45: Determination unit
50: Display control unit
60: Display and operation unit
61: Inspection state display region
62: Common information display region
63: Inspection image display region
63a, 63b: Inspection information display region
64: Operation unit region
64c: Setting and adjusting button
71: Stop button
72: Start button
A1, A2, A3: Display region
Bx1, Bx2, Bx3: Rectangle (rectangle candidate region)
Ct1, Ct2, Ct3, Ct4: Foreign object sample
Cpv: Confidence (maximum value of pixel density corresponding to confidence of each line image region, inference value)
Cpvi: Confidence (maximum value of pixel density corresponding to confidence of each first line image region, inference value)
Cpvk: Confidence (maximum value of pixel density corresponding to confidence of each second line image region, inference value)
Dcf: Inference value image
Dpr: Projection image (first projection image or second projection image)
Dpr1: First projection image
Dpr2: Second projection image
Dpx: Inspection image (X-ray transmission image, detection image)
Lx: Detection signal (detection signal corresponding to X-ray transmission amount)
Thr, Thr1, Thr2: Determination threshold value
xpi: First line image region (line image region in y-axis direction that is the other coordinate axis)
xpi′: Corresponding line image region (projection image region corresponding to first line image region)
xqk: Second line image region (line image region in x-axis direction that is one coordinate axis)
xqk′: Corresponding line image region (projection image region corresponding to second line image region)
Vc: Transport speed
W: Article (inspection object)

What is claimed is:

1. An article inspection device comprising:
an image storage unit that stores an inspection image (Dpx) of a transported inspection object (W) obtained by imaging the inspection object;
a determination unit that determines a quality state of the inspection object for the inspection image stored in the image storage unit by obtaining an inference value related to the quality state of the inspection object for each unit region of a predetermined number of pixels of the inspection image and comparing the inference value with a threshold value (Thr) set in advance using a learning model which is trained in advance using an image dataset of the same imaging condition as the inspection object;
an inference value image generation unit that generates an inference value image (Dcf) which is a two-dimensional shade image obtained using the inference value corresponding to the inspection image as a density;
a projection image generation unit that generates a projection image (Dpr) in a bar graph form by projecting a maximum value (Cpv) of the density of each of a plurality of line image regions (xpi) adjacent to each other in a direction of one coordinate axis (x) and present in a direction of another coordinate axis (y) in the inference value image to a corresponding line image region (xpi′) on the one coordinate axis with a length corresponding to the maximum value of the density; and
a display control unit that displays the projection image on a display unit by adding a line corresponding to the threshold value on the projection image.

2. The article inspection device according to claim 1,
wherein the display control unit displays the inspection image or the inference value image and the projection image in the bar graph form on the display unit by aligning positions (xi) of the plurality of line image regions and the corresponding line image regions in the direction of the one coordinate axis in accordance with a transport speed (Vc) of the inspection object in the direction of the one coordinate axis.

3. The article inspection device according to claim 2,
wherein the display control unit moves the inspection image or the inference value image on the display unit in accordance with the transport speed of the inspection object in the direction of the one coordinate axis, and displays the inspection image or the inference value image and the projection image in the bar graph form on both sides of the inspection image or the inference value image in the direction of the other coordinate axis.

4. The article inspection device according to claim 2,
wherein the projection image generation unit generates at least one of
a first projection image (Dpr1) in a bar graph form obtained by projecting a maximum value of the density of each of a plurality of first line image regions (xpi) adjacent to each other in the direction of the one coordinate axis (x) and present in the direction of the other coordinate axis in the inference value image to a corresponding first line image region on the one coordinate axis with a length corresponding to the maximum value of the density, or
a second projection image (Dpr2) in a bar graph form obtained by projecting a maximum value of the density of each of a plurality of second line image regions (xqk) adjacent to each other in the direction of the other coordinate axis and present in the direction of the one coordinate axis (x) in the inference value image to a corresponding second line image region on the other coordinate axis with a length corresponding to the maximum value of the density.

5. The article inspection device according to claim 4,
wherein the display control unit displays the inspection image or the inference value image (Dpx or Dcf) and at least one of the first projection image or the second projection image (Dpr1 and/or Dpr2) on the display unit by aligning positions (xi and/or yi) in a direction of any corresponding one or each of coordinate axes (x and/or y) for the first line image region and the corresponding first line image region and the second line image region and the corresponding second line image region.

6. The article inspection device according to claim 5,
wherein the display control unit moves the inspection image or the inference value image on the display unit in accordance with the transport speed of the inspection object in the direction of the one coordinate axis, and displays the inspection image or the inference value image and at least one of the first projection image or the second projection image in three display regions (A1, A2, A3) adjacent to each other in the direction of the other coordinate axis of the inspection image or the inference value image.

7. The article inspection device according to claim 4,
wherein the display control unit moves the inspection image or the inference value image on the display unit in accordance with the transport speed of the inspection object in the direction of the one coordinate axis, and displays the inspection image or the inference value image and at least one of the first projection image or the second projection image in three display regions (A1, A2, A3) adjacent to each other in the direction of the other coordinate axis of the inspection image or the inference value image.

8. The article inspection device according to claim 1,
wherein the display control unit moves the inspection image or the inference value image on the display unit in accordance with the transport speed of the inspection object in the direction of the one coordinate axis, and displays the inspection image or the inference value image and the projection image in the bar graph form on both sides of the inspection image or the inference value image in the direction of the other coordinate axis.

9. The article inspection device according to claim 1,
wherein the projection image generation unit generates at least one of
a first projection image (Dpr1) in a bar graph form obtained by projecting a maximum value of the density of each of a plurality of first line image regions (xpi) adjacent to each other in the direction of the one coordinate axis (x) and present in the direction of the other coordinate axis in the inference value image to a corresponding first line image region on the one coordinate axis with a length corresponding to the maximum value of the density, or
a second projection image (Dpr2) in a bar graph form obtained by projecting a maximum value of the density of each of a plurality of second line image regions (xqk) adjacent to each other in the direction of the other coordinate axis and present in the direction of the one coordinate axis (x) in the inference value image to a corresponding second line image region on the other coordinate axis with a length corresponding to the maximum value of the density.

10. The article inspection device according to claim 9,
wherein the display control unit displays the inspection image or the inference value image (Dpx or Dcf) and at least one of the first projection image or the second projection image (Dpr1 and/or Dpr2) on the display unit by aligning positions (xi and/or yi) in a direction of any corresponding one or each of coordinate axes (x and/or y) for the first line image region and the corresponding first line image region and the second line image region and the corresponding second line image region.

11. The article inspection device according to claim 10,
wherein the display control unit moves the inspection image or the inference value image on the display unit in accordance with a transport speed of the inspection object in the direction of the one coordinate axis, and displays the inspection image or the inference value image and at least one of the first projection image or the second projection image in three display regions (A1, A2, A3) adjacent to each other in the direction of the other coordinate axis of the inspection image or the inference value image.

12. The article inspection device according to claim 9,
wherein the display control unit moves the inspection image or the inference value image on the display unit in accordance with a transport speed of the inspection object in the direction of the one coordinate axis, and displays the inspection image or the inference value image and at least one of the first projection image or the second projection image in three display regions (A1, A2, A3) adjacent to each other in the direction of the other coordinate axis of the inspection image or the inference value image.
